(19) United States
(12) Patent Application Publication
(10) Pub. No.: US 2008/0223821 A1
(43) Pub. Date: Sep. 18, 2008

(54) Slotted guide structure

(75) Inventors: Emmanuel Jordana, Grenoble (FR); Jean-Marc Fedeli, Saint Egreve (FR); Loubna El Melhaoui, Grenoble (FR)

Correspondence Address: THELEN REID BROWN RAYSMAN & STEINER LLP, P. O. BOX 640640, SAN JOSE, CA, 95164-0640, US

(73) Assignee: COMMISSARIAT A L'ENERGIE ATOMIQUE, PARIS (FR)

(21) Appl. No.: 11/982,140

(22) Filed: Oct. 31, 2007

(30) Foreign Application Priority Data
Oct. 31, 2006 (FR) 06 54670

(51) Int. Cl. B29D 11/00

(52) U.S. Cl. 216/24

(57) ABSTRACT

The invention relates to a method for producing a slotted guide, in which:
a) a layer of material having a refractive index less than that of silicon is formed on a first silicon layer which itself rests on a silica SiO₂ layer, then:
b) a second silicon layer is formed on the layer of material having a refractive index less than that of silicon, this second layer forming a stack with the layer of material having a refractive index less than that of silicon and the first silicon layer, the layer of material having a refractive index less than that of silicon being contained between said two silicon layers;

c) this stack is etched, the silica layer SiO₂ forming the barrier layer for this etching.

### CROSS-REFERENCE TO RELATED PATENT APPLICATION OR PRIORITY Claim

This application claims the benefit of a French Patent Application No. 06-54670, filed on Oct. 31, 2006, the disclosure of which is incorporated herein in its entirety by reference.

### TECHNICAL FIELD AND PRIOR ART

This invention is located in the field of “Silicon Nanophotonics” (the field of guiding light in guides of nanometric dimensions), and relates primarily to optical interconnections on silicon chips and in particular the production of photonic logic gates.

Highly integrated optical functions can be produced on silicon. In a general approach, transmitters are used (integrated or added on, and electrically controlled), which are coupled with a set of guides which perform an optical function, either passively, or in response to an electrical command. These guides terminate at photodetectors which deliver the result of the optical function electrically.

The operation of a slotted guide implements propagation in a low-index medium and an index discontinuity which enables excellent containment of the light. This architecture has thus far enabled:
the conception of optical switches and light sources in photonic integrated circuits, as described in the articles by C.A. Barrios, Electronics Letters, 40, pp. 862-863, 2004 and C. A. Barrios et al, Optics Express, 13 (25), pp. 10092-10101, 2005;
the production of compact photodetectors, as described in the article by T. Baehr-Jones et al, Optics Express, 13 (14), pp. 5216-5226, 2005.

In this structure, the optical field is increased and contained in the slot, both geometrically and optically, all the more so as the slot is narrow and the refractive index contrast is high.

In order to integrate this material into the slotted guide, a manufacturing method is generally implemented as shown in FIGS. 1A-1D. A slot 3 is etched (FIG. 1B) in a SOI substrate 1 (FIG. 1A, in which the references 2 and 4 designate a SiO₂ layer and a silicon layer, respectively). Two lateral walls 7, 9 made of silicon are thus formed, on either side of this slot. Next, filling with a material 5 is carried out, as shown in FIG. 1C. A planarization and etching step results in the structure of FIG. 1D.

However, no attempt at filling has thus far been concluded, in so far as a low deposition (for example by PECVD) temperature does not allow the slot 3 to be filled. This problem is introduced in particular for a shape factor (equivalent to the ratio of the height h to the width l of the slot) greater than 1.5. This manifests itself by the formation of a bubble 10 in the slot 3, degrading the performance of the guide, as shown in FIG. 2.

Sometimes, it is impossible to fill the slot. In this case, there is not only a bubble associated with a filling defect, but a filling defect.

For example, the following various PECVD depositions were tested: SiO₂ (with a SiH₄ source) at 480° C. and 350° C., SiO₂ (TEOS, tetraethyl orthosilicate) at 400° C. and 350° C. and SiOₓ (with a SiH₄/N₂O source) at 400° C.

As can be observed in FIG. 3, showing a sectional view of a slotted guide taken with a scanning electron microscope, the slot is not filled, regardless of the type of deposition or material. For each of the tests, an air bubble appears, created by the accumulation of the deposit on the upper portion of the silicon walls.

### DISCLOSURE OF THE INVENTION

The invention proposes an alternative manufacturing method which makes it possible to avoid the difficult step of filling the slot.

The invention relates first of all to a method of producing a slotted guide, in which:
a) a layer of material having a refractive index less than that of silicon is formed on a first silicon layer which itself rests on a silica layer, then
b) a second silica layer (28) is formed on the layer of material having a refractive index less than that of silicon, this second layer forming a stack with said layer of material having a refractive index less than that of silicon and the first silicon layer, the layer of material having a refractive index less than that of silicon being contained between the two silicon layers;
c) this stack is etched, the silica layer SiO₂ forming the barrier layer for this etching.

A material having a refractive index less than that of silicon can be silicon dioxide SiO₂, or silicon nitride SiN, or non-stoichiometric SiOₓ (x<2).

In the case of non-stoichiometric SiOₓ (x<2), a method according to the invention may further comprise:
d) a annealing step of said non-stoichiometric SiOₓ, carried out after step a) and before or after one of said steps b) or c).
But, preferably, said step d) is carried out after step a) and before step b).

The invention enables an alternative horizontal-type structure to be produced (the guide layer is arranged parallel to a substrate), for which the polarisation changes, but the light containment properties remain unchanged.

The thickness of the silica layer SiO₂ forming the etching barrier layer is preferably greater than 1 μm for the purpose of preventing interference with the circuit situated below.

The silica layer can be formed by deposition on the silicon substrate, by oxygen implantation through the first silicon layer followed by annealing, or by thermal oxidation of a silicon plate.

The silica layer and the first silicon layer can be the oxide layer and the surface layer of a SOI-type substrate, respectively.

A cap for the slotted guide obtained can be made of a SiO₂ layer.

The second silicon layer can be produced in amorphous form.

The layer of material having a refractive index less than that of silicon can be formed on the first silicon layer via PECVD or LPCVD.

### BRIEF DESCRIPTION OF THE DRAWINGS

FIGS. 1A-1D show steps of a standard method for producing a slotted guide.

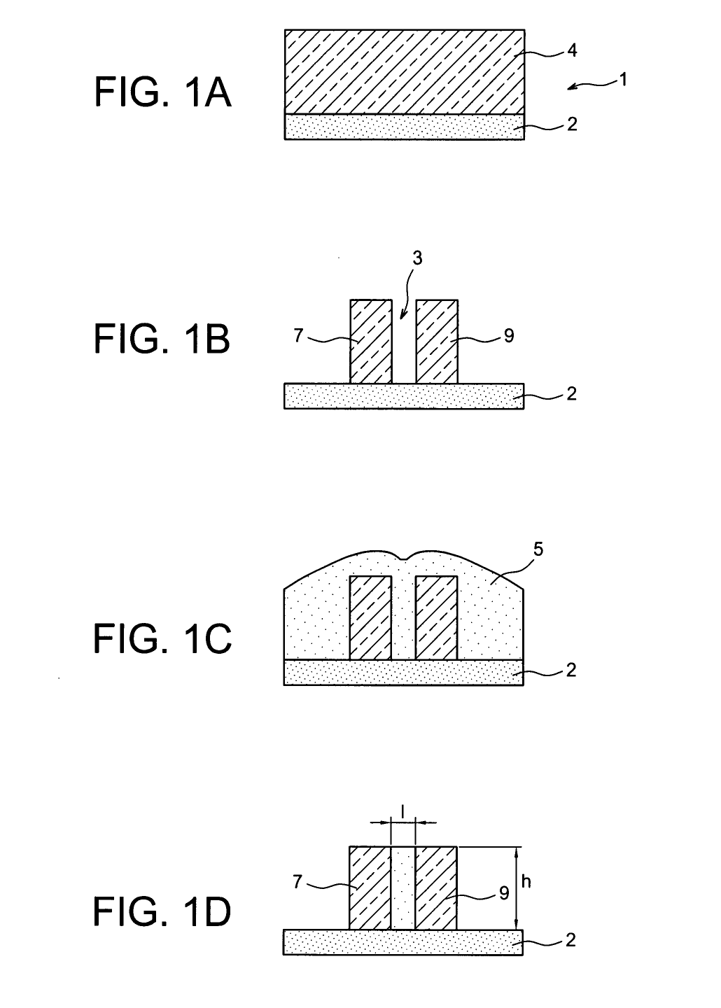

FIG. 2 shows the presence of an air bubble during a standard process for making a slotted guide.

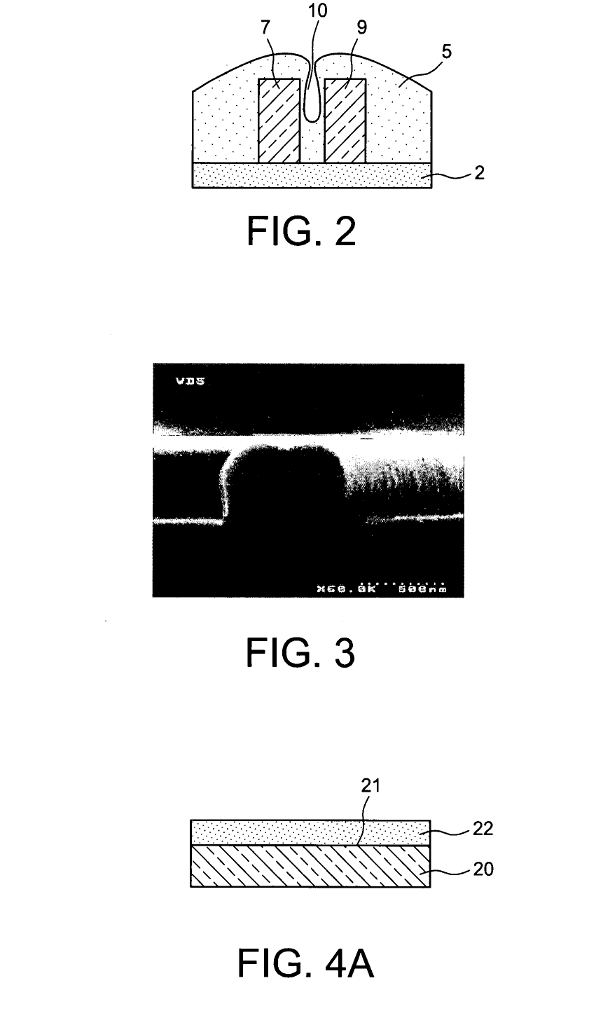

FIG. 3 is a sectional view with a SEM of a filling attempt with a standard process for making a slotted guide.

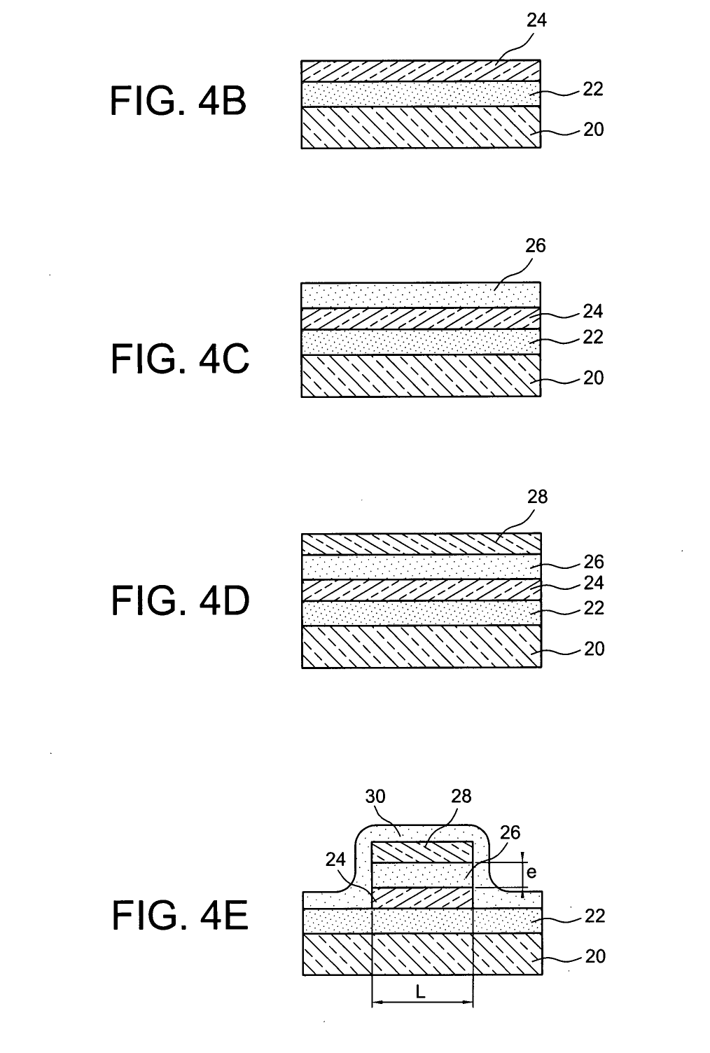

FIGS. 4A-4E are steps of a method according to the invention.

FIGS. 5A-5E are particular steps of a method according to the invention.

### DETAILED DESCRIPTION OF PARTICULAR EMBODIMENTS

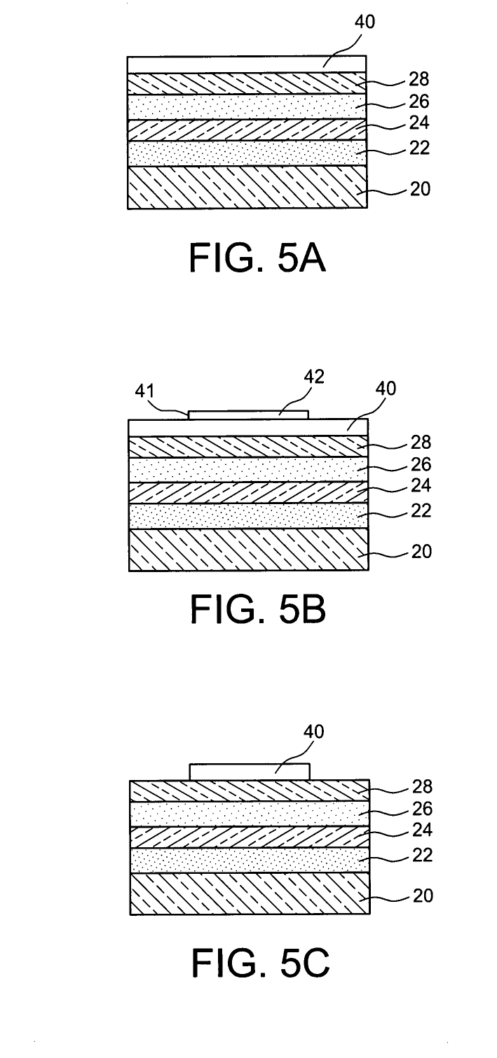

A first manufacturing method according to the invention will be described in connection with FIGS. 4A-4E.

In a first step, (FIG. 4A) the deposition or growth of a first oxide layer 22 (referred to as silica SiO₂) is carried out on a planar surface 21 of a silicon substrate 20. The layer 22 of SiO₂ can also be formed by oxygen implantation followed by annealing (SIMOX method).

A silicon layer 24 is then deposited or formed on the oxide layer 22. This layer 24, as well as the layers mentioned below, can be formed via PECVD or LPCVD.

According to the invention, it is thus possible to deposit the silicon 24 in amorphous form (PECVD deposition), using a standard silicon plate 20, having undergone a deposition 22 of silica or a thermal oxidation. The thickness of this oxide 22, preferably greater than 1 μm, is such that the losses induced by coupling with the substrate or with the CMOS circuit situated beneath the SiO₂ are prevented.

A layer 26 of material having a refractive index less than that of silicon (for example silicon dioxide SiO2, or silicon nitride SiN, or non-stoichiometric SiOₓ (x<2)) is then formed or deposited, via PECVD or LPCVD, on the silicon layer 24 (FIG. 4C).

A second deposition (FIG. 4D) of a silicon layer 28 is made on the layer 26. Said second silicon layer is preferably made in amorphous form (via PECVD), which is nearly equivalent to monocristalline silicon in terms of optical characteristics.

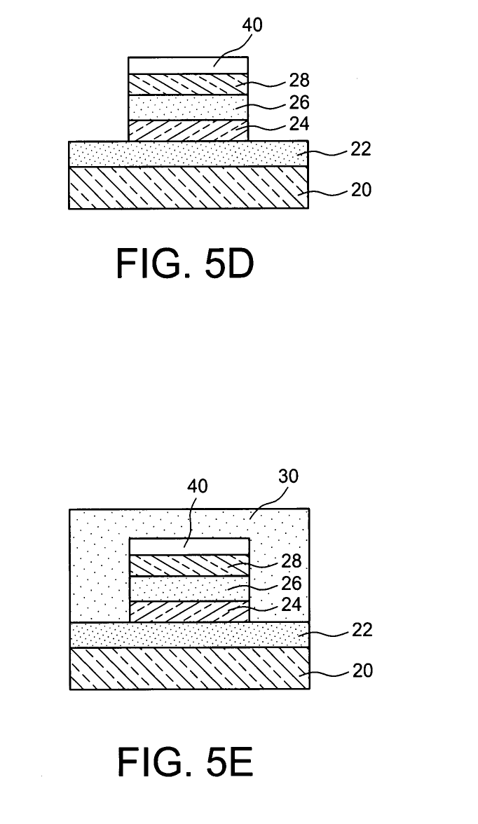

A lithographic and etching step for all of the layers 24-26-28 (FIG. 4E) is then carried out, the etching being stopped on the oxide layer 22. The function of this oxide layer is to be a barrier layer, but it also isolates the electric portion from the optical portion and makes it possible to prevent optical losses. Particular lithographic and etching sub-steps for all of the layers 24-26-28, with a hard mask, will be detailed below in connection with FIGS. 5A-5D.

Silicon layer 24 is either made in amorphous silicon (via PECVD), either in monocristalline silicon: in the last case, one starts from a stack of a silicon dioxide layer and a silicon layer, e.g. a SOI wafer.

It is also possible to produce a stack from a SOI plate having an embedded silicon layer 22, of a thickness, for example, greater than 1 μm and a desired silicon thickness 24. The deposition 26 of material having a refractive index less than that of silicon is then carried out, then the second silicon deposition 28 can be carried out in amorphous form (by means of PECVD). With amorphous silicon, there are few optical losses. The guide is then formed by lithography and etching.

Lithographic and etching steps for all of the layers 24-26-28, using a hard mask, will be detailed more specifically in connection with FIGS. 5A-5D.

For example, a hard mask layer 40, e.g., made of silica, is formed (FIG. 5A) on the silicon layer 28 of the structure of FIG. 4D.

A resin 42 is then deposited (FIG. 5B); it undergoes a lithographic process, e.g., at 248 nm, thereby enabling definition of the contours 41 of the area being etched.

The hard mask 40 is then etched, and the resin 42 eliminated (FIG. 5C).

The layers 24, 26, 28 can then be etched (FIG. 5D).

This embodiment of FIGS. 5A-5D makes it possible to avoid a problem associated with the sole use of the resin 42 as an etching mask: as a matter of fact, it is then likely to itself be entirely used up during etching of the layers 22, 24, 26, the latter thus being capable themselves of being attacked while, to the contrary, they ought to be masked. The presence of the hard mask 40 thus enables risk-free etching of the stack.

When the of material having a refractive index less than that of silicon is non-stoichiometric SiOₓ (x<2) an annealing step of the SiOₓ in order to form silicon nanocrystals can be carried out after the SiOₓ deposition and prior to the second silicon deposition 28, or after this second silicon deposition 28 and prior to etching the guide, or after etching the guide.

But, if the non-stoichiometric SiOₓ is deposited via PECVD, its thickness diminishes during annealing. In this case, it is preferable to insert the annealing step immediately after the non-stoichiometric SiOₓ deposition and prior to the second silicon deposition 28. Otherwise, line defects may appear between the non-stoichiometric SiOₓ and the Si. Furthermore, annealing has the effect of increasing the optical losses of the silicon layer.

Once the guide has been formed and etched, a SiO₂ cap 30 can be made (FIG. 4E).In the case of using a hard mask, the silica cap step 30 (TEOS method over 2 μm) is shown in FIG. 5E.

A device according to the invention has a slotted guide structure, made on a layer of silicon 22, or else in a plane parallel to the plane 21 of the substrate 20. The slot and its layer 26 of material having a refractive index less than that of silicon are thus contained between two layers of silicon 24, 28, the entire assembly resting on the silica barrier layer 22. This structure makes it possible to form the material of the slot before one of the silicon walls 24 of the guide. The production techniques involving the filling of a slot between two already formed silicon layers are thereby avoided, and thus the aforementioned bubble formation problems.

The invention is particularly advantageous for a shape factor (equivalent to the ratio of the length L to the thickness e of the slot, FIG. 4E) greater than 1.5, e.g., in the case of PECVD deposition.

The invention applies in particular to the field of optical interconnections, intra-chip optical interconnections, and optical telecommunications.

1. Method for producing a slotted guide, in which:
a) a layer of material having a refractive index less than that of silicon is formed on a first silicon layer which itself rests on a silica SiO₂ layer, then:
b) a second silicon layer is formed on the layer of material having a refractive index less than that of silicon, this second layer forming a stack with the layer of material having a refractive index less than that of silicon and the first silicon layer, the layer of material having a refractive index less than that of silicon being contained between said two silicon layers;
c) this stack is etched, the silica layer SiO₂ forming the barrier layer for this etching.

2. Method according to claim 1, the thickness of the silica SiO₂ layer forming a barrier layer for the etching being greater than 1 μm.

3. Method according to claim 1, the silica SiO₂ layer being formed by oxygen implantation through the first silicon layer followed by annealing, or by thermal oxidation of a silicon plate.

4. Method according to claim 1, the silica SiO₂ layer and the first silicon layer being the oxide layer and the surface layer of a SOI-type substrate, respectively.

5. Method according to claim 1, further including a SiO₂ layer cap for the slotted guide.

6. Method according to claim 1, the second silicon layer being produced in amorphous form.

7. Method according to claim 1, the layer of material having a refractive index less than that of silicon being formed on the first silicon layer via PECVD or LPCVD.

8. Method according to claim 1, step c) of etching the stack taking place with the aid of a hard mask.

9. Method according to claim 1, said material having a refractive index less than that of silicon being silicon dioxide SiO2, or silicon nitride SiN, or non-stoichiometric SiOₓ (x<2).

10. Method according to claim 1, said material having a refractive index less than that of silicon being non-stoichiometric SiOₓ (x<2), said method also comprising a step of:
d) annealing the non-stoichiometric silica layer SiOₓ (26) after step a), and prior to or after one of steps b) or c).

11. Method according to claim 10, the annealing step being carried out after step a) and prior to step b).

12. Method for producing a slotted guide, in which:
a) a non-stoichiometric layer of SiOₓ (x<2) is formed on a first silicon layer which itself rests on a silica SiO₂ layer, then:
b) the silica layer SiOₓ is annealed after step a), and prior to step c);
c) a second silicon layer is formed on the SiOₓ layer, this second layer forming a stack with the silica layer SiOx and the first silicon layer, the silica layer SiOₓ being contained between said two silicon layers;
d) this stack is etched, the silica layer SiO₂ forming the barrier layer for this etching;

13. Method according to claim 12, the thickness of the silica SiO₂ layer forming a barrier layer for the etching being greater than 1 μm.

14. Method according to claim 12, the silica SiO₂ layer being formed by oxygen implantation through the first silicon layer followed by annealing, or by thermal oxidation of a silicon plate.

15. Method according to claim 12, the silica SiO₂ layer and the first silicon layer being the oxide layer and the surface layer of a SOI-type substrate, respectively.

16. Method according to claim 12, further including a SiO₂ layer cap for the slotted guide.

17. Method according to claim 12, the second silicon layer being produced in amorphous or polycrystalline form.

18. Method for producing a slotted guide, in which:
a) a non-stoichiometric layer of SiOₓ (x<2) is formed on a first silicon layer which itself rests on a silica SiO₂ layer, said silica SiO₂ layer and said first silicon layer being the oxide layer and the surface layer of a SOI-type substrate, respectively, then:
b) a second silicon layer is formed on the SiOₓ layer, this second layer forming a stack with the silica layer SiOx and the first silicon layer, the silica layer SiOₓ being contained between said two silicon layers;
c) this stack is etched, the silica layer SiO₂ forming the barrier layer for this etching;
d) the silica layer SiOₓ (26) is annealed after step a), and prior to or after one of steps b) or c).

19. Method according to claim 18, the thickness of the silica SiO₂ layer forming a barrier layer for the etching being greater than 1 μm.

20. Method according to claim 18, further including a SiO₂ layer cap for the slotted guide.

21. Method according to claim 18, the second silicon layer being produced in amorphous or polycrystalline form.

22. Method according to claim 18, the silica layer SiOₓ being formed on the first silicon layer via PECVD or LPCVD.

23. Method according to claim 22, the annealing step being carried out after step a) and prior to step b).
